(19) United States
(12) Patent Application Publication
(10) Pub. No.: US 2025/0254449 A1
(43) Pub. Date: Aug. 7, 2025

(54) IN-BAND OPERATIONS AND MANAGEMENT FOR OPTICAL SWITCH

(71) Applicant: HUAWEI TECHNOLOGIES CO., LTD., SHENZHEN (CN)

(72) Inventor: Peter ASHWOOD-SMITH, Kanata (CA)

(73) Assignee: HUAWEI TECHNOLOGIES CO., LTD., SHENZHEN (CN)

(21) Appl. No.: 18/430,147

(22) Filed: Feb. 1, 2024

(51) Int. Cl. H04Q 11/00

(52) U.S. Cl. CPC H04Q 11/0005; H04Q 11/0067; H04Q 2011/003; H04Q 2011/0041

(57) ABSTRACT

Methods and apparatus for operating an optical switch in response to in-band operation and management (OAM) signals. The switch monitors for presence or absence of light at its input ports. In response to new light being present after a period of absence, the switch directs the new light to an internal receiver, which obtains control information from the light. This control information indicates an output port which is to be optically coupled to the input port. The switch then reconfigures itself to perform such an optical coupling. If light becomes absent again at the input port, the process can repeat.

### CROSS-REFERENCE TO RELATED APPLICATIONS

This is the first application filed for the present invention.

### FIELD OF THE INVENTION

The present invention pertains to optical communications, and in particular to an optical switch and the receipt and processing of associated optical switch control signals.

### BACKGROUND

All-optical switches are devices which are capable of receiving and redirecting optical communications signals toward a desired destination, without converting such signals to electrical signals. One such type of switch is a micro electrical mechanical (MEMS) switch. MEMS systems combine mechanical and electrical components and are often fabricated using semiconductor fabrication techniques. An optical MEMS switch has multiple optical input ports and multiple optical output ports, each coupled to a corresponding optical waveguide such as an optical fiber component. An array of small, controllable MEMS mirrors are included which reflect light from input ports to selectable output ports in order to establish a desired switching configuration. By positioning the mirrors, light can be caused to pass through the switch from an input port to a selected output port. The mirrors may be controlled by electrical currents applied to a mirror control mechanism. Electronic circuitry is responsive to electrical operations and management (OAM) signals to control the mirrors.

However, while the OAM signals are used to set the switch's configuration and can be received from an external source, they are, to date, electrical signals, and are also out-of-band relative to the optical signals on which the switch operates. That is, the OAM signals are separate and communicated via a separate channel and medium, compared to the optical signals being switched in response to the OAM signals. This leads to operational limitations and additional complexity, for example because the network for handling OAM signals has to be maintained separately from the optical network being supported by the all-optical switch. However, supporting in-band OAM signals, particularly in the optical domain, is a technically challenging task and to date there is limited progress in this area.

Therefore, there is a need for methods, systems and apparatus for supporting in-band OAM signalling for an optical switch such as a MEMS switch, that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

Embodiments provide for methods, systems and apparatus for supporting in-band OAM signalling for an optical switch such as a MEMS switch.

According to an aspect, there is provided an optical switch apparatus (e.g. an all-optical switch). The apparatus includes an optical input port, and typically multiple such optical input ports, a plurality of optical output ports, a controlling optical receiver, an optical switching mechanism, and a triggering optical detector. The optical switching mechanism is configured to optically couple the optical input port with a controllably selectable one of a set of elements to provide light from the input port to that one of the set of elements. The set of elements includes the plurality of optical output ports along with the controlling optical receiver. The triggering optical detector component is configured to monitor light conditions at the optical input port to detect a predetermined condition. The triggering optical detector component is further configured, in response to detection of the predetermined condition, to cause the optical switching mechanism to direct modulated light, as received at the optical input port, to the controlling optical receiver. The controlling optical receiver is configured to receive and process the modulated light to obtain control information included therein, and to cause the optical switching mechanism to couple the optical input port to a particular one of the plurality of optical output ports based on the control information.

The benefit of the optical switch apparatus disclosed herein is it supports in-band OAM signalling for an optical switch such as a MEMS switch. In addition, it mitigates operational limitations and additional complexity.

In some embodiments, the optical switching mechanism comprises a micro electrical mechanical system (MEMS) mirror array.

In some embodiments, the apparatus includes a tap configured to receive and redirect a portion of light from the optical input port toward the triggering optical detector component.

In some embodiments, the apparatus includes a leaky reflector configured to receive and redirect, via reflection, a major portion of light from the optical input port toward the controllably selectable one of the set of elements. The leaky reflector is also configured to receive and redirect, via admission through the leaky reflector, a remaining portion of said light from the optical input port toward the triggering optical detector component.

In some embodiments, the predetermined condition comprises absence of light at the optical input port for at least a predetermined time period. In some embodiments, the predetermined condition comprises absence of light at the optical input port for at least a predetermined time period, followed by presence of light at the optical input port.

In some embodiments, the modulated light immediately precedes or is part of an optical signal received at the optical input port for redirection to said particular one of the plurality of optical output ports.

According to another aspect, there is provided a method performed by an optical switch apparatus. The method includes, by a triggering optical detector component of the optical switch: monitoring light conditions at an optical input port, of the optical switch, to detect a predetermined condition; and in response to detection of the predetermined condition, causing an optical switching mechanism, of the optical switch, to direct modulated light, as received at the optical input port, to a controlling optical receiver of the optical switch. The method includes, by the controlling optical receiver: receiving and processing the modulated light to obtain control information included therein; and causing the optical switching mechanism to couple the optical input port to a particular one of a plurality of optical output ports based on the control information.

In some embodiments of the method, the optical switching mechanism comprises a micro electrical mechanical system (MEMS) mirror array.

In some embodiments of the method, the monitoring light conditions at the optical input port includes receiving and redirecting a portion of light from the optical input port toward the triggering optical detector component.

In some embodiments of the method, the monitoring light conditions at the optical input port includes receiving and redirecting, via admission through a leaky reflector, a minor portion of light from the optical input port toward the triggering optical detector component.

In some embodiments of the method, the predetermined condition comprises absence of light at the optical input port for at least a predetermined time period. In some embodiments of the method, the predetermined condition comprises absence of light at the optical input port for at least a predetermined time period, followed by presence of light at the optical input port.

In some embodiments of the method, the modulated light immediately precedes or is part of an optical signal received at the optical input port for redirection to said particular one of the plurality of optical output ports.

According to an aspect, there is provided a system comprising multiple devices selected from: one or more optical switches such as described above, a source apparatus, and a destination apparatus.

According to an aspect, there is provided a method of operating an optical switch, such as the above-described optical switch apparatus. The method includes . . .

The above method can include other operations or features, for example commensurate with embodiments of the optical switch apparatus as already described above.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates an optical switch responsive to out-of-band OAM signals, according to the prior art.

FIG. 2 illustrates an optical switch responsive to in-band OAM signals, according to embodiments of the present disclosure.

FIG. 3 illustrates an optical switch responsive to in-band OAM signals, according to other embodiments of the present disclosure.

FIGS. 4A to 4C illustrate operation of an optical switch responsive to in-band OAM signals, according to embodiments of the present disclosure.

FIG. 5 illustrates in-band OAM signalling from a source to a destination, and used to configure intermediate optical switches, according to embodiments of the present disclosure.

FIG. 6 illustrates an electronic device which may be configured to perform operations according to embodiments of the present disclosure.

It will be noted that throughout the appended drawings, like features are identified by like reference numerals.

### DETAILED DESCRIPTION

Embodiments of the present disclosure pertain to an optical switch, such as but not necessarily limited to a MEMS optical switch, which is responsive to in-band OAM signals to set its switching configuration of coupling input ports to output ports. The optical switch is an all-optical switch in the sense that optical signals provided to the switch's input ports are routed to the switch's output ports fully in the optical domain, i.e. without conversion to electrical signals. The OAM signals are in-band in the sense that the OAM signals are transmitted and handled using the same optical media and components which are also used to transmit and handle the optical signals which are being controlled on the basis of the OAM signals. The OAM signals may further be in-band in the sense that the OAM signals and the optical signals which are being controlled on the basis of the OAM signals have a same or similar range of wavelengths. For example, the OAM signals may occupy a known and predetermined band of wavelengths, which may be the same as or different from wavelengths carrying data. However, the optical switch may treat the OAM signal wavelength bands and the data wavelength bands in the same manner from a switching perspective, i.e. by applying any switching activity to an overall band of wavelengths including both OAM signals and data.

The in-band OAM signals are received at the switch's input ports, where the switch operates to controllably connect these same input ports to output ports, according to content of the OAM signals. The switch distinguishes the in-band OAM signals from other signals using some criterion, and sends the OAM signals to control components of the switch. The control components then interpret the OAM signals and utilize them to operate the switch, i.e. to optically couple an input port to a specified output port using mirrors or other switching fabric components. In some but not necessarily all embodiments, the OAM signals received at a particular input port are interpreted as being instructions for connecting that same input port to an output port determined according to these OAM signals.

As used herein, the term “OAM signal” pertains to a signal which is used, at least in part, to control operation of a switch with respect to coupling input ports to output ports, so as to controllably direct a signal received at a particular input port to a specified output port.

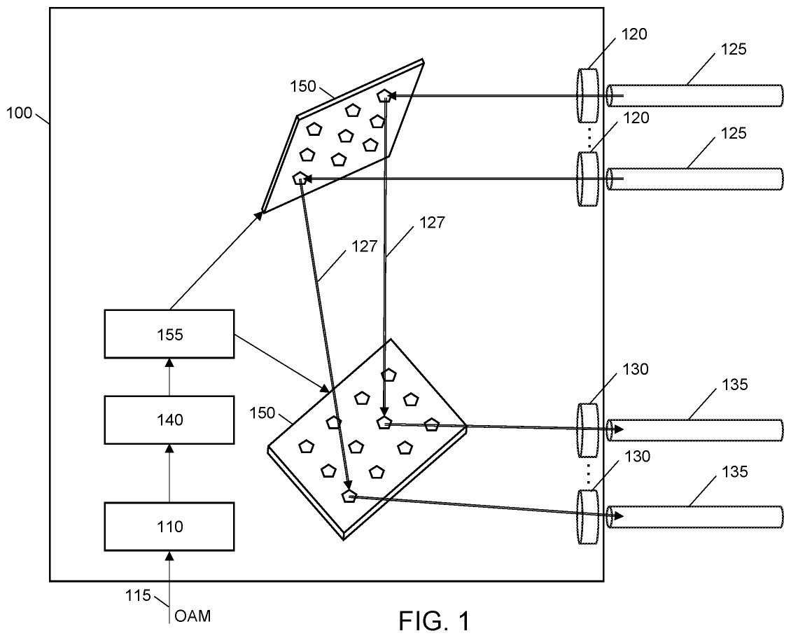

For purposes of comparison, FIG. 1 illustrates an optical switch 100 with an out-of-band OAM interface 110, according to a hypothetical prior art. The switch 100 includes a plurality of optical input ports 120 coupled to input optical fibers 125 and a plurality of optical output ports 130 coupled to output optical fibers 135. The switch 100 further includes a controller 140 such as a computer processor, a MEMS mirror array 150, and MEMS mirror control components 155. The mirrors of the MEMs mirror array are controllably adjustable, e.g. in angle(s), to couple each input port to a corresponding output port, by alignment of movable mirrors to reflect light from an input port toward such a corresponding output port. For example, each MEMS mirror may be controllable with respect to two angular degrees of freedom. The mirror control components 155 operate mirrors of the MEMS mirror array to adjust their angle(s). For example, the mirror control components 155 may include adjustable current drivers, where the MEMS mirrors respond to an applied current with a corresponding adjustment in angle(s). Examples of out-of-band OAM signals include signals which are received via a dedicated interface and medium that is separate from the beams of light which are handled and redirected by the switch. That is, the switch's data ports do not normally deal with (e.g. decode contents of and respond to) messages or packets received at its data ports, but instead just redirect beams of light from input ports to output ports without attempting to decode their contents.

The controller 140 receives and processes externally received OAM signals 115 received at the OAM interface 110 and, in response to these OAM signals, causes the MEMS mirror control components 155 to operate the mirrors of the MEMS mirror array 150 to couple particular input ports to particular output ports, corresponding to content of the OAM signals. Arrows 127 show example paths of light which might be established according to such optical couplings. Notably, the OAM interface 110 is separate from the input optical fibers 125 and the OAM signals 115 are not carried via these input optical fibers. Accordingly, the OAM signals are out-of-band relative to signals carried by the input optical fibers. The OAM interface 110 may be an electrical port taking serial commands and a command line interface, although web based interfaces, remote procedure calls or other methods of communicating between some external controlling entity and the switch's controller 140 are possible. In contrast to embodiments of the present disclosure, for the optical switch 100, the OAM signals are not provided as optical signals via input ports 120. Therefore, a separate out-of-band OAM signalling network needs to be provided, increasing complexity.

The MEMS mirrors of the array 150 can be controllably repositioned to reflect light from an input port to a desired output port via carefully computed reflections off of one or more intermediary mirrors. These mirrors may be micro mechanical (MEMS) mirrors etched onto a chip. The mirrors may be controlled by current applied to the mirror control components 155. The controller 140 can program the positions of the mirrors in response to the OAM signals 115.

Various other details and aspects of the optical switch 100 will be readily understood by a worker skilled in the art, for example with reference to “An Introduction to MEMS Optical Switches,” Tung, Meng Fai, Dec. 13, 2001.

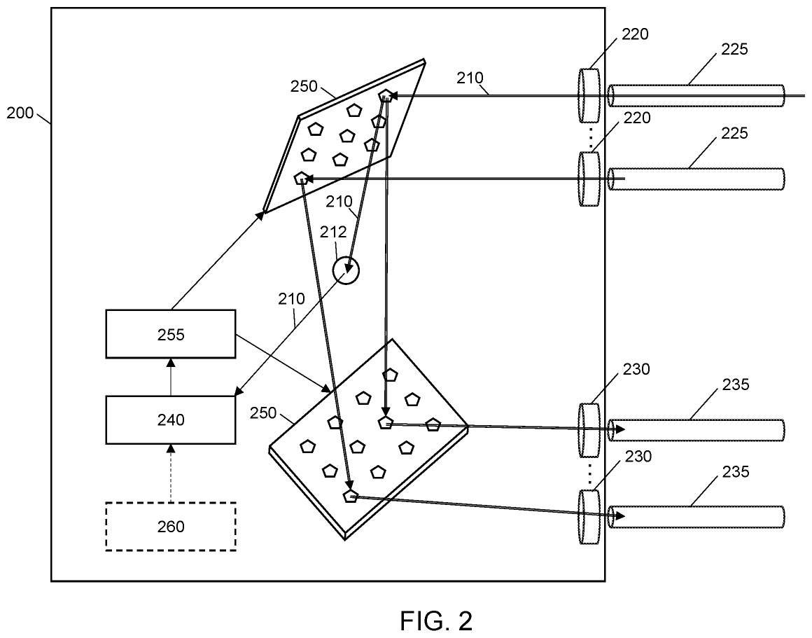

FIG. 2 illustrates an optical switch 200 with an in-band OAM interface, according to an embodiment of the present disclosure. The switch 200 includes a plurality of optical input ports 220 coupled to input optical fibers 225 and a plurality of optical output ports 230 coupled to output optical fibers 235. The switch 200 further includes a controller 240 such as a computer processor, a MEMS mirror array 250, and MEMS mirror control components 255. The controller 240 and the MEMS mirror control components 255 can be separate or integrated together. As with FIG. 1, the mirrors of the MEMs mirror array are controllably adjustable, e.g. in angle, to couple each input port to a corresponding output port, by alignment of movable mirrors to reflect light from an input port toward such a corresponding output port. In fact, various aspects of operation of the switch 200, apart from the communication and processing of OAM signals, can be the same as or similar to the corresponding aspects of operation of the switch 100 of FIG. 1. The mirror control components 255 operate the mirrors of the MEMS mirror array to adjust their angles. For example, the mirror control components 255 may include adjustable current drivers, where the MEMS mirrors respond to an applied current with a corresponding adjustment in angle. The controller 240, MEMS mirror array 250 and MEMS mirror control components 255 may together provide an optical switching mechanism.

Although embodiments are described herein primarily with respect to the usage of a MEMS mirror array, it is contemplated that other mechanisms for optically coupling input ports with output ports, without converting signals to the electrical domain, can be also used. For example, the MEMS mirror array may be replaced with an array of controllable macroscopic mirrors, or other controllable reflectors, refractors, a network of interferometric components which controllably direct light to a selected output, or the like, or a combination thereof. The switch may thus be configured to couple entire input optical signals to a controllably selectable output port, including substantially all wavelengths of such input optical signals. Various details of such controllable switching fabrics and their operation will be readily understood by a worker skilled in the art.

The controller 240 receives and processes OAM signals received via optical input ports, and operates the switch 200 in response to such in-band OAM signals. (It is noted that input and output capabilities can be present on any port so that, for various purposes, a port can be considered to be an input port or an output port depending on the direction of propagation of optical signals.) Ultimately, in response to these OAM signals, the controller 240 causes the MEMS mirror control components 255 to operate the mirrors of the MEMS mirror array 250 to couple particular input ports to particular output ports, corresponding to content of the OAM signals. An example path 210 for such an OAM signal is shown, including an optical-to-electrical conversion 212. Mechanisms by which the controller receives the in-band OAM signals are described elsewhere herein.

In some embodiments, the switch 200 may also have an out-of-band OAM interface 260 similar to the interface 110 of the switch 100 of FIG. 1. This OAM interface can be used as an additional or alternative mechanism for controlling the switch 200, e.g. as a backup or to facilitate multiple modes of operation. However, in this case the switch 200 is also responsive to in-band OAM signals as described above and elsewhere herein.

Although the switch 200 includes multiple optical input ports, some embodiments may have only a single optical input port.

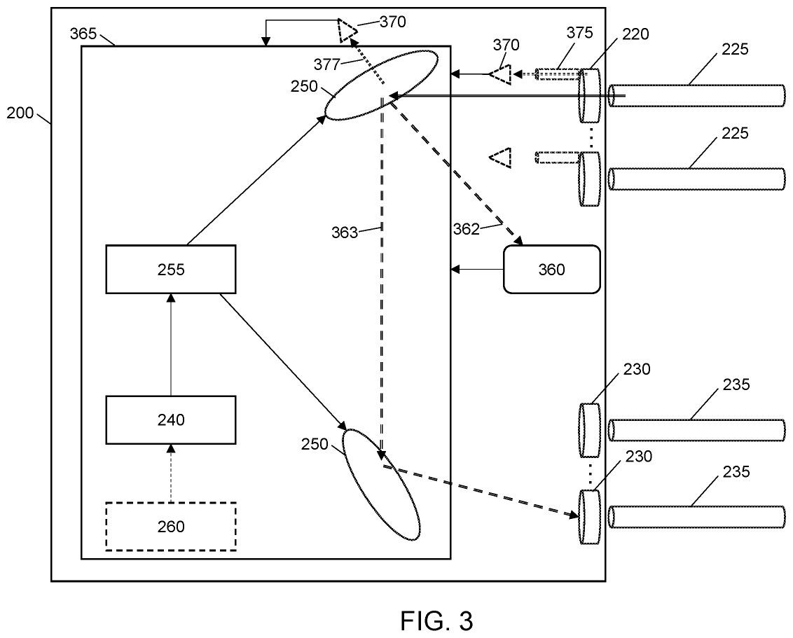

FIG. 3 illustrates an optical switch 300 in accordance with another embodiment of the present disclosure. The switch 300 includes an optical input port 220 coupled to an input optical fiber 225 and a plurality of optical output ports 230 coupled to output optical fibers 235. Multiple such optical input ports may be, and typically are, present. The optical switch further includes a controlling optical receiver 360. The controlling optical receiver can receive light from the optical input port 320 under certain conditions, as described below, and can correspondingly be used in operation of the switch 300 based on in-band OAM signals contained therein.

The optical switch 300 further includes an optical switching mechanism 365, which is configured to optically couple the optical input port with a controllably selectable one of a set of elements. The optical switching mechanism 365 can include, by way of example, an array of MEMS mirrors 250 and corresponding MEMS mirror control components 255 (e.g. current drivers, etc.) and a controller 240, such as a computer processor or other electronic circuitry, which is separate from or integrated with the MEMS mirror control components 255. The optical switching mechanism 365 is responsive to predetermined input conditions to couple the optical input port 220 with an appropriate optical output port 230, for example using MEMS mirror actuation methods as would be readily understood by a worker skilled in the art. The optical switching mechanism may additionally be responsive to signals from an out-of-band OAM interface 260 (not necessarily included) as described above.

In more detail, the optical switching mechanism may operate to provide light from the optical input port 220 (e.g. substantially all light provided to the input port) to the selected one of a certain set of elements. The set of elements includes the plurality of optical output ports 230 as well as the controlling optical receiver 360. Thus, light from the optical input port can be directed either to an appropriate optical output port or to the controlling optical receiver, where it may be received and at least partially processed to obtain in-band OAM signals. The controlling optical receiver may then respond by passing corresponding signals onward to the optical switching mechanism 365 for control thereof. These corresponding signals may be electronic representations of the in-band OAM signals. The direction to the appropriate one of the set of elements may involve reflection off one, two or more mirrors of the MEMS mirror array 250. Some example reflection paths are shown via dashed arrows 362, 363.

In some embodiments, a single mirror may be used to redirect light from the optical input port to the controlling optical receiver, whereas two or more mirrors may be used to redirect light from the optical input port to an optical output port.

The optical switch 300 further includes a triggering optical detector component 370. Two different potential locations for the triggering optical detector component are shown for use with the optical input port 220. The triggering optical detector component is configured to monitor light conditions at the optical input port 220 to detect a predetermined condition. The predetermined condition may be, for example, absence of light at the optical input port for at least a predetermined time period, e.g. on the order of 100 milliseconds, as a non-limiting example. Absence of light may be defined as light levels below a predetermined threshold, e.g. below a level detectable by the triggering optical detector component 370. The predetermined condition may be, for example, absence of light at the optical input port for at least a predetermined time period, followed by presence of light at the optical input port. The triggering optical detector component 370 is further configured, in response to detection of the predetermined condition, to cause the optical switching mechanism 365 to direct (modulated) light, as received at the optical input port from an external source, to the controlling optical receiver 360. Although not shown, the triggering optical detector component can be coupled more specifically to the controller 240 or MEMS mirror control components 255 for this purpose. This modulated light will be expected to contain the in-band OAM signals.

The controlling optical receiver 360, which also includes a photodetector of suitable bandwidth and speed, will then receive and process the modulated light to obtain control information (e.g. routing or switching control information) that is included in (encoded into) the modulated light, by way of such modulation. Then, the controlling optical receiver 360 will cause the optical switching mechanism 365 to couple the optical input port 320 to a particular one of the optical output ports 330, based on the control information. Although not shown, the controlling optical receiver can be coupled more specifically to the controller 240 (or possibly the MEMS mirror control components 255) for this purpose. The optical switching mechanism 365 may establish the required optical coupling by adjusting the MEMS mirrors 250 to redirect light from the optical input port 220 toward one of the optical output ports 230 selected according to the control information.

Therefore, in various embodiments, following a period in which no light is present at the optical input port 220, the optical switch 300 will couple the optical input port to the controlling optical detector 360. In this way, the controlling optical detector 360 can be used to monitor for in-band OAM signals presented at the optical input port 220, and perform switching operations in response to such in-band OAM signals.

The triggering optical detector component 370 may include an optical detector along with associated electronic circuitry. Optical detectors may be of a variety of types, for example a photodiode with appropriate sensitivity and selectivity.

In order to operate, the triggering optical detector component's optical detector may be provided with a small fraction of the light which is provided to the input port 220. This fraction of light may have a bandwidth which is the same as the full bandwidth of light provided to the input port, or which is a fraction of this full bandwidth. In some embodiments, an optical tap 375 may be provided, for example at the input port, which routes this fraction of light toward the triggering optical detector component. The optical tap thus receives and redirects a limited portion of light from the optical input port 320 toward the triggering optical detector component 370.

In some embodiments, a (e.g. MEMS) mirror which receives light from the input port may be configured to leak a limited portion of this light through its reflective surface, with the triggering optical detector component's optical detector located behind the mirror and configured to receive this leaked light 377. Such a device may be referred to as a leaky reflector. In more detail, the leaky reflector (e.g. an instance of component 250) may be configured to receive and redirect, via reflection, a major portion of light from the optical input port toward a destination, e.g. a controllably selectable one of the set of elements (230, 360) as mentioned above. The leaky reflector is further configured to receive and redirect, via transmission through the leaky reflector's generally reflective surface, a remaining portion 377 of the light from the optical input port toward the optical detector of the triggering optical detector component 370. The triggering optical detector component's optical detector is thus placed behind the leaky reflector. The triggering optical detector component 370 may be highly sensitive to light, thus detecting presence of light on the basis of a relatively small number of photons. The signal from the triggering optical detector component's optical detector can be amplified significantly for use by electronic components and controllers.

Other mechanisms for splitting off a portion of the light from the input port and routing same to the triggering optical detector component, such as refractive or reflective mechanisms, may also be used. To maintain efficiency, the portion of light split off for this purpose should be suitably small, e.g. from approximately one photon to a few hundreds of photons, as a non-limiting example, while also being sufficiently large for proper operation of the detector.

Notably, according to some embodiments, there are two types of optical-to-electronic transducers. The first type of transducer is the triggering optical detector component 370. This first type of transducer is used to monitor for a predetermined trigger condition and to direct light toward the second optical detector in response to this trigger condition. In some embodiments, there are multiple instances of the first type of transducer, for example one triggering optical detector component dedicated to each input port. The second type of optical transducer is the controlling optical receiver, and is used in the transformation of control information (e.g. in-band OAM signals) from the optical domain to the electrical domain, to facilitate operating the switch according to such control information.

In some embodiments, there is a single instance of the second type of optical transducer. Alternatively, there may be two or more instances of the second type of optical transducer. Two or more controlling optical receivers may be shared by some or all input ports, or each may be dedicated to a subset of input ports, or the like, or a combination thereof. In some embodiments, if a shared controlling optical receiver is not currently available (due to it being used by another input port), the switch may reserve usage of a controlling optical receiver when it becomes available. A controlling optical receiver may become available once control information is received at an input port and the process of coupling the input port to a specified output port is begun. A controlling optical receiver may become available once the switching fabric operates to decouple an input port from the controlling optical receiver.

In some embodiments, by having multiple relatively simple triggering optical detectors, e.g. one dedicated triggering optical detector per optical input port, and fewer (e.g. a single) more complex controlling optical receivers, optical switch cost and complexity may be controlled.

In some embodiments, rather than having a dedicated triggering optical detector for each input port, one or more triggering optical detectors may be shared by multiple input ports. Such a triggering optical detector may be shared via a time-varying scan pattern (time division multiplexing) for example.

According to embodiments, the optical switch can be prompted to respond to in-band OAM signals by a temporary cessation of light provided to an input port. The optical switch will then monitor this input port for OAM signals in the above-described manner. The optical switch may be responsive to a predetermined condition separately at each such input port, to monitor for such OAM signals.

Additional details according to embodiments of the present disclosure are provided below.

It is considered that the isolation of a complete optical wavelength or optical fiber for the purposes of OAM is likely too expensive in terms of wasted bandwidth. OAM usually requires fairly small amounts of control messaging relatively infrequently, certainly compared to the large bandwidth that a wavelength or fiber provides. As a result, prior art pure optical switches do not provide in-band OAM capabilities and instead require a separate physical OAM network.

In various embodiments, when an optical switch detects (e.g. using an associated triggering optical detector) an absence of light at an optical input port for a predetermined time period, the switch will proactively reconfigure (e.g. via MEMS mirror adjustments) to optically couple that optical input port with the controlling optical receiver, or a selected one of a plurality of controlling optical receivers, if present. This sets up the switch proactively to process any light, when eventually received at the optical input port, to determine the potential presence of control information (e.g. OAM signals) included therein via optical modulation.

In various embodiments, when an optical switch detects the presence of light at an optical input port following an absence of light at that optical input port for a predetermined time period, the switch will reactively reconfigure to optically couple that optical input port with the controlling optical receiver, or a selected one of a plurality of controlling optical receivers, if present. This sets up the switch to process the light, once received at the optical input port, to determine the potential presence of control information (e.g. OAM signals) included therein via optical modulation. In this case, it may be required to repeat the control information or prepend the control information with a preamble optical signal, or the like. This will allow time for the optical switch to detect the presence of light and couple the input port with the controlling optical receiver, in time to receive and process the control information. Therefore, when an optical signal is received at a previously idle input port, the switch processes this optical signal to obtain control information, and reconfigures to effect a cross connect between the input port and an output port specified according to the control information (OAM signal). Cross connection activity is thus directed by the source of the light being received at the input port. This allows the configuration and switching intelligence to be placed at the edge of the network. Furthermore, in the event of an OAM network outage, edge switches can create a light path.

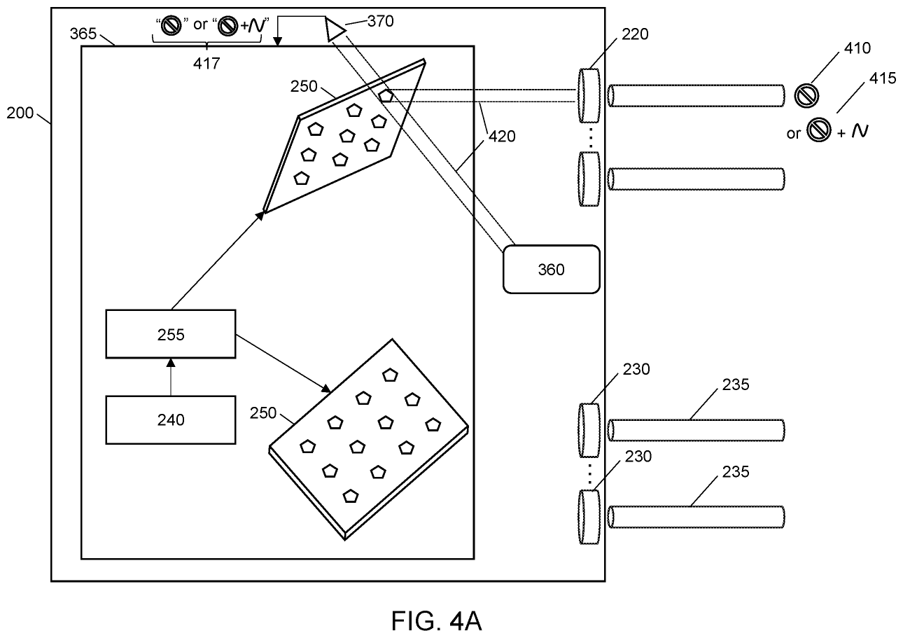

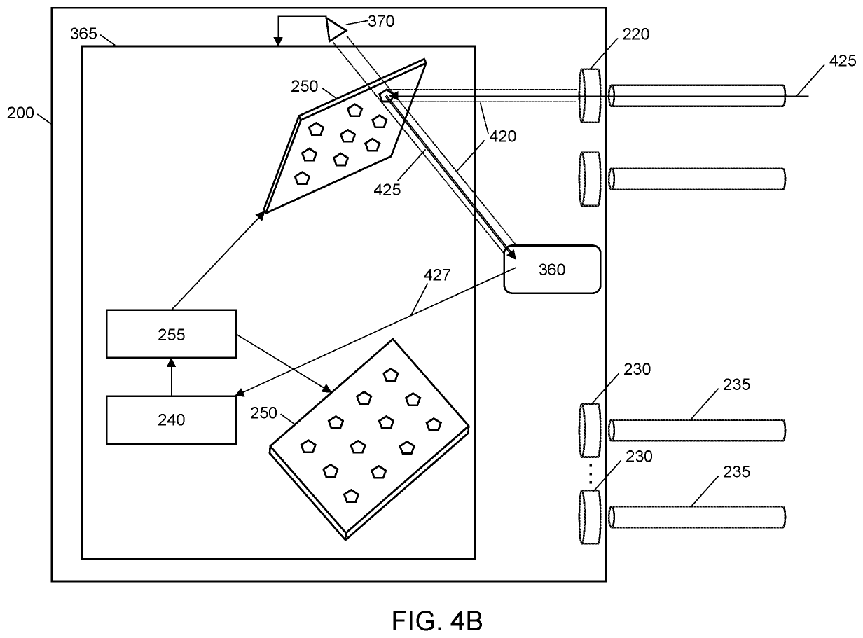

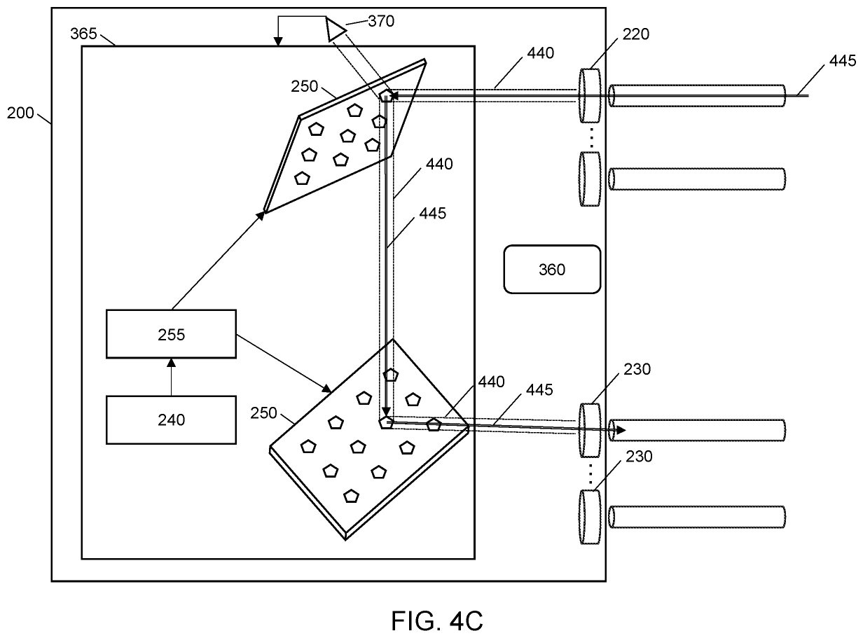

FIG. 4A illustrates an optical switch 200 prepared to direct control information from an input port 220 to the controlling optical receiver, for example in response to detecting a condition 410 of absence of light for a predetermined period at the input port 220, or alternatively in response to detecting a condition 415 of presence of light following absence of light for the predetermined period at the input port 220. The triggering optical detector component 370 informs the optical switching mechanism 365 of such a condition via signal 417. The optical switching mechanism 365 in response optically couples, by establishing the optical path 420, the input port 220 with the controlling optical receiver 360 in preparation for receiving and interpreting control information to be presented to the optical input port 220. Alternatively, the optical switching mechanism may respond in this manner in the absence of any signal from the triggering optical detector component.

In various embodiments, the configuration of FIG. 4A represents a resting or default configuration (or quiet mode), with respect to the optical input port 220. That is, in a resting or default configuration, the optical switch 200 establishes the optical path 420 between the input port 220 and the controlling optical receiver 360.

In some embodiments, when a controlling optical receiver is shared by multiple input ports, signals from the triggering optical detector components (e.g. each dedicated to a particular input port) may be used to assist in determining which input port is receiving control information, if necessary. An internally monitored state of the optical switch (e.g. state of the MEMS mirror array) can be additionally or alternatively used for this purpose.

In various embodiments, one, two or more switches may cooperate to establish a desired light path from a source (SRC) to a destination (DST). At least one of the switches may be as already described above.

A source can generate and transmit control information (e.g. OAM signals), via modulation (e.g. frequency, amplitude, pulse width, on/off, etc.) of optical signals, toward a switch, prior to transmitting signals to be directed by the switch according to the control information. The signals may follow the control information at an appropriate time such that the switch has configured itself according to the control information to output the signals via an appropriate output port. The signals may include control information for use by subsequent switches. The time gap (if any) between the control information and such signals may be such that the switch maintains the switching state that was just established by the control information. For example, a dark period between control information and signals, that would cause the switch to change back to directing light toward the controlling optical receiver, may need to be avoided. Alternatively, the control information may include instructions to cause the switch to enter the desired switching state at a particular specified time.

In some embodiments, the source may generate the control information by modulating light in a simple low-speed format suitable for interpretation by the controlling optical receiver. This may be an on/off modulation to signify a series of bits. The source can then encode onto these bits the desired control information. The control information may include, for example, the output port to be coupled to the input port, or an identity of an ultimate destination to connect to, which the switch can use along with routing table information to determine the appropriate output port to couple to the input port.

In this manner, the source may encode control information to be used by multiple switches in succession. Different parts of the control information may be for use by different switches. The source may encode such control information in a variety of ways. In some embodiments, the source may encode the control information to indicate identities of a set of fibers it wishes to use to connect to a destination. Such control information may constitute an explicit source route. The fibers in this case may need unique identifiers encoded sequentially in the message. In some embodiments, the source may encode the control information to indicate the identity of a set of switches it wishes to use to connect to a destination. The switches in this case may constitute a loose source route. The switches in this case may need unique identifiers encoded sequentially in the message. In some embodiments, the source may encode the control information to indicate the identity of the final destination it wishes to connect with. This may correspond to establishment of a routed connection. The destination port may require a unique identity. In all of the above cases there are known technologies for selecting outgoing ports based on routed, or source routed incoming messages. In any case, because the switch is receptive to control information after a period of no light input, these messages are decoded by the decoder array (controlling optical receiver) rather than forwarded as raw light to an output port. Accordingly, the switch treats them as control information such as OAM messages, for operating the switch.

FIG. 4B illustrates an optical switch, following its preparation as in FIG. 4A, receiving the control information 425 from its input port 220 and directing the control information to the controlling optical receiver 360 via the established optical path 420. The controlling optical receiver 360 sends corresponding information 427 to the controller 240, or otherwise causes operation of the optical switching mechanism 365. For example, the information 427 can be an electronic version of the control information 425, following conversion by the controlling optical receiver 360. In another example, the information 427 can include instructions causing the optical switching mechanism 365 to establish a certain optical path from the optical input port 220 to a selected optical output port 230, as shown in FIG. 4C.

FIG. 4C illustrates an optical switch 200 subsequently configured according to the control information 425/427 as received in FIG. 4B. The optical switch is configured, in particular, to optically couple the input port 220 to one of the output ports 230 that was specified in or otherwise determined from the control information. The optical switching mechanism is operated to establish an optical path 440 from the optical input port 220 to a particular one of the optical output ports 230 as shown. This path 440 can then carry an optical signal 445.

In more detail with respect to FIG. 4C, and in some embodiments, the optical switch's controller 240, in receipt of the control information (OAM message) provided at the input port 220, may verify that the control information (e.g. 425, 427) is correct. The controller may then cause the optical switching mechanism 365 of the switch to optically couple the input port 220 to the output port 230 specified in the control information. For example, the optical switching mechanism 365 can include the switch's MEMS switching fabric 250. At this point, the controller 240 will cease to have access to content of signals 445 presented to the input port. Instead, these signals 445 will be directed toward a device coupled to the specified output port 230, such as another switch or a destination device.

In various embodiments, the configuration of FIG. 4C can be regarded as being a pass-through state with respect to the optical input port 220. That is, the input port 220 and output port 230 are optically coupled, with the optical switch refraining from monitoring content or interpreting signals presented at the optical input port using the controlling optical receiver 360. However, even in this pass-through state, the triggering optical detector component 370 may monitor the optical input port to detect absence of light, which would trigger, or be part of triggering, reversion to the state of FIG. 4A. The pass-through state is entered after processing of the control information (OAM signal) is completed.

In various embodiments, the above-described optical coupling of input port to output port is maintained until another predetermined trigger condition is met. This trigger condition can be, for example, absence of light at the optical input port for a predetermined period, or presence of light following absence of light at the optical input port for a predetermined period, as specified above. Other trigger conditions may also be specified.

If the next device coupled to the specified output port is another optical switch of the same type, this optical switch can operate similarly to the above-described optical switch, i.e. being responsive to further control information presented thereto.

Traversing a series of multiple optical switches in the above manner, with each optical switch sequentially configured according to in-band OAM signals as specified by a source, the source can configure multiple optical switches to optically couple the source to a desired destination device. Once light from the source reaches the destination device's optical transceiver, the transceiver may recognize the OAM signalling, and perform some verification operations. The destination device may also act as a source to initiate, using OAM signalling, establishing a reverse optical path to the original source, now acting as destination. The original source may eventually detect this reverse path and may thus determine that a two-way path with the destination has been established. If, on the other hand, too much time has elapsed without such a path being established, the original source can switch off its light, thus prompting the optical switches to restart their process of monitoring for OAM signals.

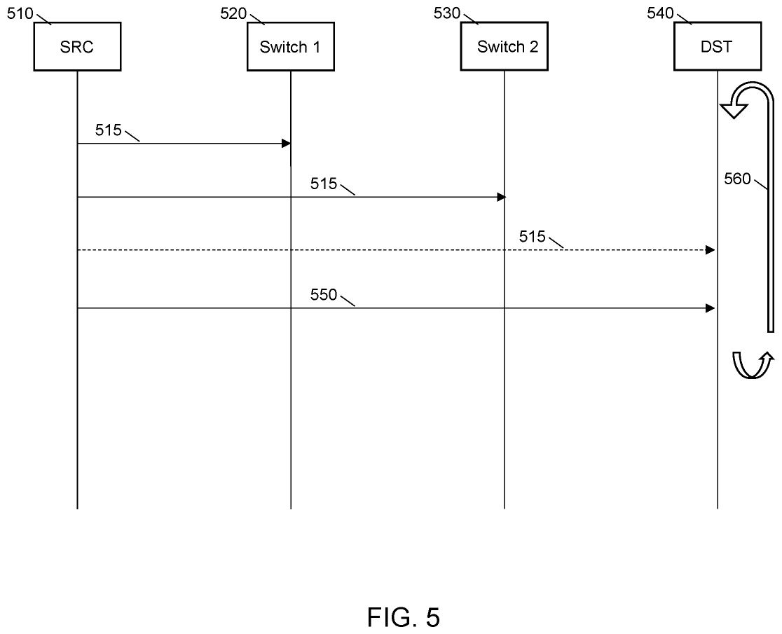

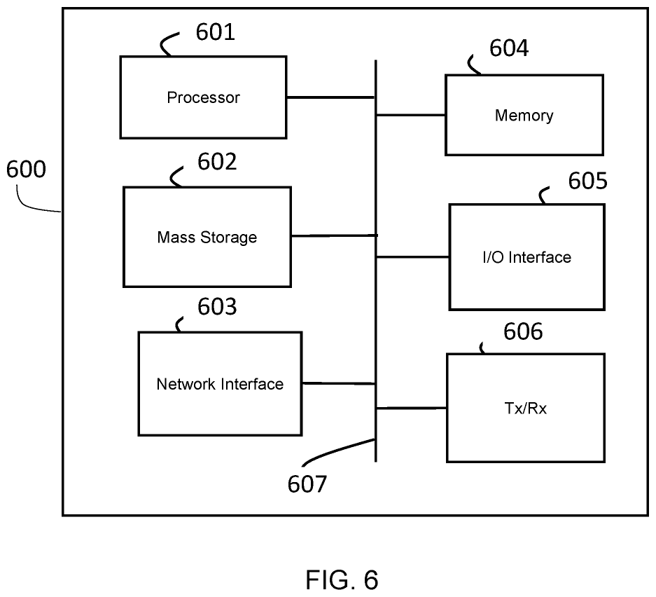

FIG. 5 illustrates a process by which a source device 510 configures multiple switches using in-band OAM signaling, according to an embodiment of the present disclosure. The source device 510 provides an in-band OAM signal 515 to a first optical switch 520, following a period during which the source device has provided no light to the first optical switch 520. It is assumed that the first optical switch is coupled to the source device via a dedicated first input port. The first optical switch receives and interprets a first part of the OAM signal 515 which designates that the first input port is to be coupled to a first output port. This first output port is in turn coupled via fiber to a dedicated second input port of a second optical switch 530. The second optical switch receives and interprets a second part of the OAM signal 515 which designates that the second input port is to be coupled to a second output port. This second output port is in turn coupled via fiber to a dedicated input port of a destination device 540. The two switches thus respond to the OAM signal 515 by establishing a path from the source device 510 to the destination device 540.

In some embodiments, portions of the OAM signal 515 are “consumed” as the OAM signal propagates from switch to switch. That is, a first part of the OAM signal is directed to the controlling optical receiver of the first switch, where it is interpreted and not passed onward toward the second switch. A second part of the OAM signal, following the first part of the OAM signal, is passed on toward the second switch, following the first switch making the required input port to output port coupling. The second part of the OAM signal may be similarly consumed at the second switch, potentially leaving no remaining part of an OAM signal to be received at the destination device 540, or alternatively leaving a special portion of the OAM signal to be received at the destination device 540. Data 550 can then be sent from the source device 510 to the destination device 540, via the first and second switches. If the source device 510 subsequently ceases transmitting light toward the first input port of the first optical switch 520, both optical switches will detect an absence of light and will reset 560 to a state of monitoring for in-band OAM signals.

Embodiments may be applicable to an environment consisting of multiple electrical computing devices which require light paths between themselves, that vary slowly over time. The electrical computing devices may be coupled with fibers to a set of pure optical MEMS switches. In such embodiments, the MEMS switches may be configured periodically to create dedicated light paths between the electrical computing devices. For example for the purposes of providing massive direct bandwidth between electrical computing devices performing massive computations, AI training, data movements etc. This kind of architecture may be significantly less expensive than using electrical switches end to end due to the costs of electrical to optical conversions at each hop. Architecturally, in such embodiments, the MEMS switches may be configured only with information about which fibers connect where but not about end to end paths. It would then be up to the electrical computing devices to request the optical paths as they need them by bringing up light, encoding setup information and once complete, using the light path as per normal. Once they no longer require the path, they can release it by turning off their light. In this manner the fibers can be used in a slow statistical manner and shared among all the edge electrical computing devices without a central control system. A slow edge based recovery mechanism may also be implicit in this method, because if a source detects that it is not able to communicate, it can bring the light down and retry, thus possibly bypassing a broken segment.

Embodiments may comprise a data center having servers coupled to electrical switches, and the electrical switches being coupled to one or more layers of pure optical MEMS based switches, before being coupled again to the electrical switches and servers. The architecture permits configuration of dedicated optical paths between the electrical switches and thus between servers. In this embodiment the combination of an electrical switch and a compute server can be considered as a single electrical compute server coupled to the MEMS switches. The servers may require massive bandwidth among themselves for periods of time such as hours/days/weeks. Such embodiments may gain advantages from the statistical nature of the fiber usage and from being able to easily allocate fibers to/from specific circuits at the request of the end servers/switches rather than a central OAM system.

It is noted that output ports of a switch can be addressed in various ways. For example, an output port can be addressed using the name of a switch (e.g. X3) composed with the name of a fiber coupled to the output port (e.g. F2). Provided that the name is unique within an optical network, OAM logic of a switch can select an appropriate outgoing fiber without necessarily knowing its position (hop number) within an end-to-end path from source to destination.

According to a particular embodiment, by way of illustration, a (e.g. MEMS based) optical switch allows some light to leak through one or more of its mirror components. The light triggers, using a triggering optical detector, a signal to the switch's controller (e.g. CPU) to identify presence/absence of light at an input port. When light is absent the switch is configured (e.g. by positioning of the mirror component) to direct light (once received) to a detector array (controlling optical receiver) which allows the controller to directly couple to a source of light at the far end of the input fiber. The controller can then then process OAM messages from the source of the fiber and react to those messages to reconfigure its input and output mirrors to effect the desired switching operation as indicated by the source of the messaging and the content of the OAM messages. Once the switch is configured in this manner, it maintains such configuration until light is no longer detected at the input port, at which point switch again reconfigures to direct light to the detector array.

As used herein, routing refers to the logic (e.g. involving hardware, software, or both) that determines how information (packets or bits or light) should move from a source to a destination through a set of one or more intermediate switches. Ultimately, routing determines what configurations the individual switches should have to instantiate a desired end to end route.

As used herein, switching refers to the hardware, software, or both which causes the packets, bits or light to follow a desired end to end path or route. Switching can involve mirrors to reflect light, hardware to move packets from input buffers to output buffers based on many different types of decision about the packet, or other technologies, or a combination thereof. As is evident from the above, embodiments of the present disclosure are concerned with switching effected by reflecting light off (e.g. MEMS) mirrors to cause the desired input to output fiber relationship from end to end.

In some embodiments, the switch itself may be capable of generating in-band OAM signals to be used by other downstream switches. Thus, the switch may act similarly to a source to direct other switches.

FIG. 5 is a schematic diagram of an electronic device 500 that may perform certain operations of the above methods and features explicitly or implicitly described herein, according to embodiments of the present disclosure. For example, a computer equipped with network function may be configured as an electronic device 500. Such an electronic device may be used as part of one or more of: a controller, a source device, an optical switch, a destination device, or an electronic switch. Multiple such devices networked together may be used to perform operations as described herein. Networked computing devices can host various functions as described herein, and may employ network function virtualization or similar technology to facilitate such hosting.

As shown, the device includes processor 501, such as a Central Processing Unit (CPU) or specialized processors such as a Graphics Processing Unit (GPU) or other such processor unit, memory 504, non-transitory mass storage 502, I/O interface 505, network interface 503, and transceiver 506, all of which are communicatively coupled via bi-directional bus 507. According to certain embodiments, any or all of the depicted elements may be utilized, or only a subset of the elements. Further, electronic device 500 may contain multiple instances of certain elements, such as multiple processors, memories, or transceivers. Also, elements of the hardware device may be directly coupled to other elements without the bi-directional bus. Additionally or alternatively to a processor and a memory, other processing electronics, such as application specific integrated circuits, field programmable gate arrays, digital circuitry, analog circuitry, or the like, or a combination thereof may be employed for performing the required logical operations. Each integrated circuit may include one or more of semiconductor chips, and semiconductor chiplets.

Memory 504 may include any type of non-transitory memory such as static random access memory (SRAM), dynamic random access memory (DRAM), synchronous DRAM (SDRAM), read-only memory (ROM), any combination of such, or the like. Mass storage element 502 may include any type of non-transitory storage device, such as a solid state drive, hard disk drive, a magnetic disk drive, an optical disk drive, USB drive, or any computer program product configured to store data and machine executable program code. According to certain embodiments, memory 504 or mass storage 502 may have recorded thereon statements and instructions executable by processor 501 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. An optical switch apparatus comprising:
an optical input port;
a plurality of optical output ports;
a controlling optical receiver;
an optical switching mechanism configured to optically couple the optical input port with a controllably selectable one of a set of elements to provide light from the input port to said one of the set of elements, the set of elements including the plurality of optical output ports and the controlling optical receiver; and
a triggering optical detector component configured to:
monitor light conditions at the optical input port to detect a predetermined condition; and
in response to detection of the predetermined condition, cause the optical switching mechanism to direct modulated light, as received at the optical input port, to the controlling optical receiver,
wherein the controlling optical receiver is configured to receive and process the modulated light to obtain control information included therein, and to cause the optical switching mechanism to couple the optical input port to a particular one of the plurality of optical output ports based on the control information.

2. The apparatus of claim 1, wherein the optical switching mechanism comprises a micro electrical mechanical system (MEMS) mirror array.

3. The apparatus of claim 1, further comprising a tap configured to receive and redirect a portion of light from the optical input port toward the triggering optical detector component.

4. The apparatus of claim 1, further comprising a leaky reflector configured to receive and redirect, via reflection, a major portion of light from the optical input port toward the controllably selectable one of the set of elements, and to receive and redirect, via admission through the leaky reflector, a remaining portion of said light from the optical input port toward the triggering optical detector component.

5. The apparatus of claim 1, wherein the predetermined condition comprises absence of light at the optical input port for at least a predetermined time period.

6. The apparatus of claim 1, wherein the predetermined condition comprises absence of light at the optical input port for at least a predetermined time period, followed by presence of light at the optical input port.

7. The apparatus of claim 1, wherein the modulated light immediately precedes or is part of an optical signal received at the optical input port for redirection to said particular one of the plurality of optical output ports.

8. A method comprising, by an optical switch apparatus:
by a triggering optical detector component of the optical switch:
monitoring light conditions at an optical input port, of the optical switch, to detect a predetermined condition; and
in response to detection of the predetermined condition, causing an optical switching mechanism, of the optical switch, to direct modulated light, as received at the optical input port, to a controlling optical receiver of the optical switch; and
by the controlling optical receiver:
receiving and processing the modulated light to obtain control information included therein; and
causing the optical switching mechanism to couple the optical input port to a particular one of a plurality of optical output ports based on the control information.

9. The method of claim 8, wherein the optical switching mechanism comprises a micro electrical mechanical system (MEMS) mirror array.

10. The method of claim 8, wherein said monitoring light conditions at the optical input port comprises receiving and redirecting a portion of light from the optical input port toward the triggering optical detector component.

11. The method of claim 8, wherein said monitoring light conditions at the optical input port comprises receiving and redirecting, via admission through a leaky reflector, a minor portion of light from the optical input port toward the triggering optical detector component.

12. The method of claim 8, wherein the predetermined condition comprises absence of light at the optical input port for at least a predetermined time period.

13. The method of claim 8, wherein the predetermined condition comprises absence of light at the optical input port for at least a predetermined time period, followed by presence of light at the optical input port.

14. The method of claim 8, wherein the modulated light immediately precedes or is part of an optical signal received at the optical input port for redirection to said particular one of the plurality of optical output ports.
